(19) United States
(12) Patent Application Publication
(10) Pub. No.: US 2008/0191570 A1
(43) Pub. Date: Aug. 14, 2008

(54) Pivot Bearing Device, Particularly for a Rotating circular Table of a Machine Tool

(75) Inventors: Richard Negele, Esslingen (DE); Thomas Dittenhofer, Riedbach (DE); Martin Schreiber, Herzogenaurach (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: Schaeffler KG, Herzogenaurach (DE)

(21) Appl. No.: 11/914,022

(22) PCT Filed: May 10, 2006
(86) PCT No.: PCT/EP06/04382

§ 371 Date: Nov. 9, 2007

(30) Foreign Application Priority Data
May 25, 2005 (DE) 10 2005 024 004.6

(51) Int. Cl. H02K 7/09; F16C 29/06

(52) U.S. Cl. 310/90.5; 384/455

(57) ABSTRACT

A pivot bearing device, particularly for a rotating circular table of a machine tool is provided, and includes a first device part, which is to be connected to an element that is to be rotatably mounted, particularly to the circular table, and a second fixed device part. The device parts are connected via at least one antifriction bearing upon which an axial force acts. A magnet device (21), which acts between the first and second device parts (2, 3), is provided for generating a compensating force (Fₖ) oriented in essentially the opposite direction to the axial force (Fₐ).

### BACKGROUND

The invention relates to a pivot bearing device, particularly for a rotating circular table of a machine tool, comprising a first device part, which is to be connected to an element, which is to be rotatably mounted, particularly to the circular table, and comprising a second fixed device part, wherein these device parts are connected using at least one anti-friction bearing, on which an axial force acts.

Pivot bearing devices are typically used to support a first element so that it can rotate relative to a fixed second element. An embodiment to be named is a machine tool with a circular table, which is moved, for example, in a clocked way, and which is held so that it can rotate relative to the machine frame or the like using the pivot bearing device. Known pivot bearing devices comprise a first device part, which is coupled with the element to be supported rotatably, for example, the circular table, and a second fixed device part, which is connected, for example, to the machine frame or the like. The two device parts are connected rotatably to each other by at least one anti-friction bearing.

In a typical horizontal arrangement of the pivot bearing device, an axial force resulting essentially from the weight of the first device part, from the similarly constant own weight of the coupled element, for example, the table, and also a variable weight portion from a workpiece to be processed and the clamping means arranged, for example, on the circular table, for attaching the workpiece, etc., acts on the one or more anti-friction bearings. Furthermore, for example, from the processing of the workpiece or the like and also from any unbalanced masses, radial forces, such as possible tilting moments resulting from unbalanced masses and processing forces, also act on the one or more anti-friction bearings.

The static axial forces are the primary factor deciding the service life of the bearing. To avoid any difficulties resulting from this, the anti-friction bearing that is used is dimensioned accordingly. This is cost intensive, sometimes structural difficulties are also produced, and furthermore, the maximum rotational speed is limited.

### SUMMARY

The invention is based on the objective of providing a pivot bearing device, in which the problems resulting from the axial force acting on the one or more anti-friction bearings can be at least partially compensated.

To meet this objective, it is provided according to the invention that, for a pivot bearing device of the type noted above, a magnetic device acting between the first and the second device parts for generating a compensating force directed essentially opposite the axial force is provided.

The pivot bearing device according to the invention is distinguished by the use of a magnetic device, by which a compensating force can be generated, which necessarily acts on the one or more anti-friction bearings because the magnetic device is arranged between the two device parts or acts between these and which is directed opposite the axial force. A permanent force of attraction, which is directed opposite the own weight-related axial force and which compensates this axial force, acts between both device parts through the magnetic device. The resulting force actually acting on the one or more anti-friction bearings can thus be compensated to a large degree according to the layout of the magnetic device. Thus it is also possible to use relatively small anti-friction bearings with a simultaneously sufficiently long service life, which can also operate at high continuous rotational speeds. Advantageously, hydrostatic bearings or the like can be eliminated.

The magnetic device itself preferably comprises several permanent magnet elements, which are arranged on the first or on the second device part and which interact with the other, opposing device part. Each opposing device part is obviously metallic, so that the permanent magnet elements and the opposite device part necessarily attract each other. Here, it is not significant whether the permanent magnets are now arranged on the first device part, which is turned actively by a drive motor, or on the second, fixed device part.

As an alternative to the arrangement of the permanent magnet elements on only one device part, it is obviously also conceivable to arrange the several permanent magnet elements on the first and on the second device parts opposite each other, wherein the permanent magnet elements are naturally aligned with their poles accordingly, so that they attract each other.

According to an especially preferred construction of the invention, in which the permanent magnet elements are arranged at least on the first device part, which rotates, it is especially advantageous that the first device part with the permanent magnets simultaneously forms or comprises the rotor of a motor driving the first device part and the second device part forms the stator of the motor. The motor is preferably constructed as a disk-shaped torque motor. In this embodiment, the motor is integrated on the device side and forms a part of the pivot bearing device. Such a torque motor preferably allows a direct drive. The permanent magnets are arranged on the disk-shaped rotor, which is formed by the first device part or which is part of this first device part, for the torque motor constructed here as a disk armature. Lying above these parts at a distance in the axial direction is the second device part, which forms or comprises the stator and which obviously provides all of the electrotechnical or electromagnetic components necessary for forming a torque motor. This construction is especially advantageous since both an integrated direct drive and also the magnetic load compensation according to the invention are achieved through the construction of the torque motor as a horizontally arranged disk armature.

As an alternative to the use of a disk-shaped torque motor, the permanent magnet elements can also interact as purely passive elements with the metallic or magnetic counterpart. The first device part can be coupled or is coupled in this part with the rotary drive of a motor, especially an electric motor with a worm gear. The permanent magnets are also arranged here for generating the axial compensating force preferably on a disk, which lies horizontally in the installed position and which is coupled with the rotary drive and which forms a part of the first device part and which interacts with the second device part lying opposite and spaced apart in the axial direction, wherein this second device part also forms somewhat of a stator.

Preferably a combined radial-axial bearing, especially in the form of a cylinder anti-friction bearing, is used as the anti-friction bearing. Alternatively, two or more rows of angular contact ball bearings can also be provided.

In addition to the pivot bearing device, the invention further relates to a machine tool comprising a rotating circular table, which provides a pivot bearing device according to one of the described embodiments.

### BRIEF DESCRIPTION OF THE DRAWINGS

Additional advantages, features, and details of the invention emerge from the following description of an embodiment. Shown herein are:

FIG. 1 a section view of a block diagram of a pivot bearing device according to the invention with an attached circular table, and

FIG. 2 an enlarged detail view of the pivot bearing device from FIG. 1.

### DETAILED DESCRIPTION OF THE PREFERRED EMBODIMENTS

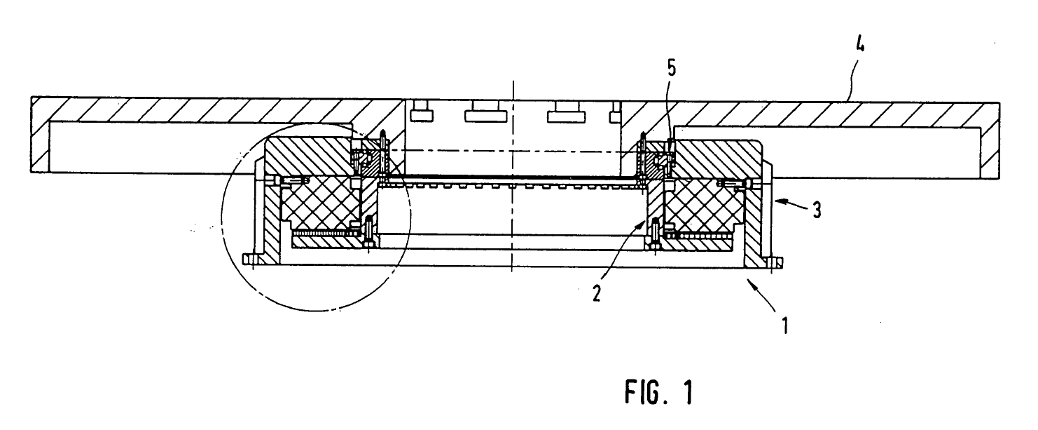

FIG. 1 shows a pivot bearing device 1 according to the invention comprising a first device part 2 that can rotate in the mounted state and a second device part 3 that is fixed in the installed position. In the shown embodiment according to FIG. 1, a circular table 4, on which, for example, various clamping devices can be placed for holding a workpiece or the like, is arranged on the first device part. The first device part 2 and the second device part 3 are joined in rotation to each other by a combined two-part pivot bearing 5, wherein the pivot bearing 5 comprises a radial bearing 6 and also two axial bearings 7. It involves, for example, a combined radial-axial cylinder anti-friction bearing.

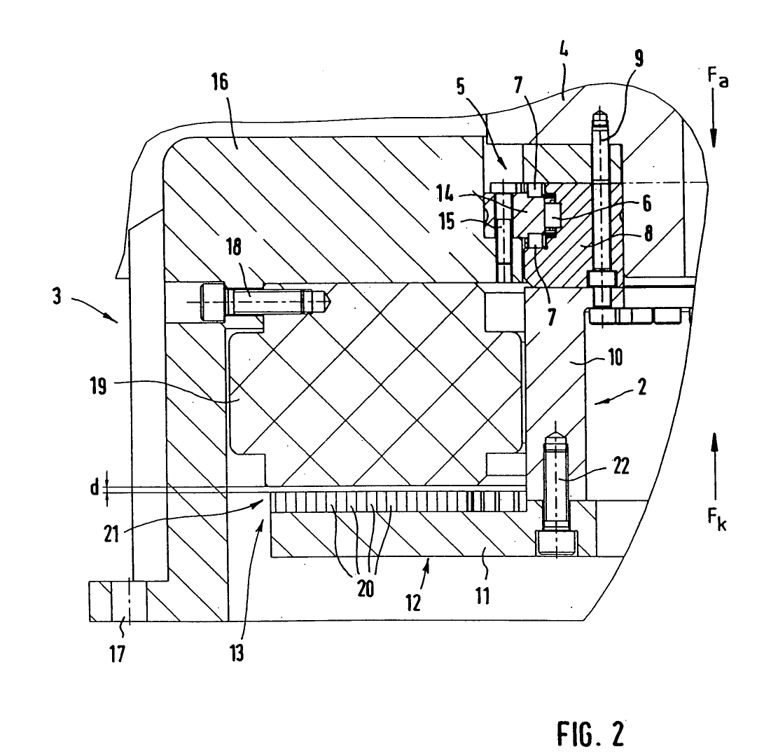

As FIG. 2 further shows, on one hand, the circular bearing table 4 is fixed to the inner annular bearing part 8 by screw connections 9 and, on the other hand, a motor disk 11, which is fixed to the intermediate piece 10 by screw connections 22, is arranged above an intermediate piece 10. The intermediate piece 10 and also the motor disk 11 form part of the first device part. The motor disk 11 forms the rotor 12 of a torque motor 13 constructed here as a disk armature, which will be discussed in more detail below.

The bearing housing 16, which is locked in rotation, for example, with the machine frame, by attachment means guided by corresponding attachment boreholes 17, is arranged on a second bearing part 14 by screw connections 15. A stator 19, which forms the torque motor 13 together with the rotor 12, is further connected to the bearing housing 16 by additional screw connections 18. The bearing housing 16 and also the stator 19 are part of the second, fixed device part.

A plurality of permanent magnets 20 are arranged, preferably distributed over the entire disk plane, on the side directed toward the stator 19 on the motor disk 11 forming the rotor 12. In the stator itself are the electromagnetic components, such as exciter coils, etc., necessary for implementing the torque motor 13, not shown in more detail. These components do not need to be discussed in more detail. In principle, a torque motor involves a multiple-pole, permanently excited synchronous motor, wherein, in a known way the permanent magnets are arranged on the rotor, while on the stator the individually wound coils are arranged at a high packing density, by which high magnetic forces can be generated when the coils are energized. Typically, the individual coils or the winding heads are arranged between the stator sheets. Because almost no friction is generated in such torque motors, these motors are essentially maintenance free. The basic construction of a torque motor has long been known to those skilled in the art, so that it does not need to be discussed in more detail. The central elements also must be provided in the torque motor designed here as a disk armature.

A static axial force Fₐ in the axial direction, which results, on one hand, from the own weight of the first device part 2, here, the bearing part 8, the intermediate piece 10, as well as the motor disk 11, and the additional attachment elements or other components, which form the first device part 2, acts continuously on the anti-friction bearing 5. Added to this are also the force components resulting from the weight of the circular table 4 itself, any clamping elements, as well as workpieces to be processed, etc., on the table.

This axial force Fₐ can be compensated to a certain degree or to a large extent by a compensating force acting in the opposite direction. This compensating force Fₖ is generated by the magnetic device 21 provided between the first and the second device part 2, 3, here formed by the permanent magnets 20 in connection with the stator 19, between which a magnetic coupling acts outward from the housing. Permanent forces of attraction act between the permanent magnets 20 and the stator 19 such that the rotor 12 generates a compensating force Fₖ directed opposite the axial force Fₐ via the connection piece 10. This compensating force Fₖ is also generated during the operation of the torque motor 13, because the permanent magnets 20 and the stator 19, which are separated from each other by the air gap d, also continuously attract each other. The generated compensating force depends on how strong the force of attraction of the magnetic device 21 is, which can be set in the end by the magnetic field strength that can be generated by the permanent magnets 20.

For the embodiment described in FIGS. 1 and 2, an integrated torque motor 13 is provided as described. This means that no additional drive element must be provided. A double function is given to the torque motor, namely, on one hand, the rotational driving of the circular table 13 and, on the other hand, the function of load compensation, that is, the function of generating the compensating force Fₖ.

Alternatively, however, the construction can be such that instead of an integrated torque motor, the first device part 2 is coupled with a separate drive, for example, a conventional electric motor with a worm gear. This drive is flanged, for example, to the motor disk 11. In this case, as is shown in FIG. 2, the permanent magnets 20 distributed over the disk plane are located on the motor disk 11. Because the rotary drive is external to the pivot device, a stator no longer has to be provided. That is, instead of the stator 19 shown in FIG. 2, a simple metallic element, just a correspondingly dimensioned metal ring, can be integrated, which interacts with the permanent magnet 20. It is also naturally conceivable to use a suitable sheet-metal package arrangement for generating the magnetic forces or for interacting with the permanent magnets 20, wherein the arrangement is selected so that when the table rotates, eddy currents, which could be induced due to the rotation, are largely prevented. In this embodiment, the two first and second device parts 2, 3 would also attract each other, which would also result in the generation of the compensating force Fₖ for the use of an external drive. Here, there is naturally the possibility of arranging not only corresponding permanent magnet elements 20 on the motor disk 11, but also on the opposing part of the second device part, so that the magnetic coupling could be reinforced.

### LIST OF REFERENCE NUMBERS

1 Pivot bearing device
2 Rotating device part
3 Fixed device part
4 Circular table
5 Anti-friction bearing
6 Radial bearing
7 Axial bearing
8 Bearing part
9 Screw connections
10 Intermediate piece
11 Motor disk
12 Screw connections
13 Torque motor
14 Bearing part
15 Screw connections
16 Bearing housing
17 Attachment boreholes
18 Screw connections
19 Stator
20 Permanent magnets
21 Magnetic device
22 Screw connections
Fₐ Axial force
Fₖ Compensating force
d Air gap

1. Pivot bearing device for a rotating circular table of a machine tool, comprising a first device part connected to an element to be supported rotatably, and a second fixed device part, the device parts are connected by at least one anti-friction bearing, on which an axial force acts, a magnetic device acting between the first and the second device parts is provided for generating a compensating force directed essentially opposite the axial force.

2. Pivot bearing device according to claim 1, wherein the magnetic device comprises several permanent magnet elements, which are arranged on the first or second device part and which interact with the other, opposing one of the first or second device part.

3. Pivot bearing device according to claim 1, wherein the magnetic device comprises several permanent magnet elements, which are arranged opposite each other on the first and second device parts.

4. Pivot bearing device according to claim 2, wherein the permanent magnet elements are arranged at least on the first device parts the first device part with the permanent magnet elements simultaneously forms or comprises a rotor of a motor driving the first device part and the second device part simultaneously forms or comprises a stator of the motor.

5. Pivot bearing device according to claim 4, wherein the motor is a disk-shaped torque motor.

6. Pivot bearing device according to claim 1, wherein the first device part can be coupled or is coupled with a rotary drive an electric motor with a worm gear.

7. Pivot bearing device according to claim 1, wherein a combined radial-axial bearing in the form of a cylinder anti-friction bearing, or two or more rows of angular contact ball bearings are provided as anti-friction bearings.

8. Machine tool comprising a rotating circular table, which is supported by a pivot bearing device according to claim 1.

9. Pivot bearing device according to claim 1, wherein the device includes a circular table as the element to be supported rotatably.
